(19) United States
(12) Patent Application Publication
(10) Pub. No.: US 2026/0080345 A1
(43) Pub. Date: Mar. 19, 2026

(54) Machine-Learning-Based Identification of Financial Transaction Supervision Events

(71) Applicant: Statement Technologies LTD, Tel Aviv (IL)

(72) Inventors: Idan VLODINGER, New York, NY (US); Shahar LAHAV, Tel Aviv (IL)

(21) Appl. No.: 18/888,520

(22) Filed: Sep. 18, 2024

(51) Int. Cl. G06Q 10/0639

(52) U.S. Cl. CPC G06Q 10/06395

(57) ABSTRACT

There is provided a processor-based system of identifying a financial transactions supervisory event, the processor configured to: utilize machine learning models to classify a plurality of financial transactions of an organization, thereby resulting, for each of the financials transactions, in one or more respective generated transaction attributes, apply a predefined transaction rule to the classified transactions, the applying comprising: evaluating a transaction matching criterion that is at least partially based on one or more of the respective generated attributes of the classified transactions, the classified transactions matching the transaction matching criterion thereby constituting a set of selected transactions, determining a selected transactions characteristic (STC), based on, one or more transaction characteristics of the transactions constituted in the set of selected transactions, evaluating a supervisory event criterion (SEC), the supervisory action criterion being based on the STC, and identifying a financial transactions supervisory event, responsive to positive evaluation of the SEC.

### TECHNICAL FIELD

The presently disclosed subject matter relates to monitoring of financial transactions, and in particular to implementation of systems utilizing machine learning to identify events of interest among such transactions.

### BACKGROUND

Problems of implementation in systems of financial transaction supervision have been recognized in the conventional art and various techniques have been developed to provide solutions.

### GENERAL DESCRIPTION

According to one aspect of the presently disclosed subject matter, there is provided a system of identifying a financial transactions supervisory event, the system comprising a processing circuitry configured to:
a) utilize one or more machine learning models to classify a plurality of financial transactions of an organization, thereby resulting, for each of the financials transactions, in one or more respective generated transaction attributes,
each of the machine learning models having been trained utilizing, at least, training data derived from historical financial transactions of the organization, and associated classification labels; and
b) apply a predefined transaction rule to the classified transactions, the applying comprising:
   a. evaluating, for each of the classified transactions, a transaction matching criterion that is at least partially based on one or more of the respective generated attributes of the classified transactions, the classified transactions matching the transaction matching criterion thereby constituting a set of selected transactions,
   b. determining a selected transactions characteristic (STC), the determining being based on, at least, one or more transaction characteristics of the transactions constituted in the set of selected transactions,
   c. evaluating a supervisory event criterion (SEC), the supervisory action criterion being based on, at least, the STC, and
   d. identifying a financial transactions supervisory event, responsive to, at least, positive evaluation of the SEC.

In addition to the above features, the system according to this aspect of the presently disclosed subject matter can comprise one or more of features (i) to (iii) listed below, in any desired combination or permutation which is technically possible:
(i) applying additionally comprises:
e. creating a supervisor alert based on the identifying a financial transactions supervisory event.
(ii) the processing circuitry is configured to perform applying that comprises:
determining an STC that is a statistic based on a transaction characteristic of each transaction of the set of selected transactions
(iii) the processing circuitry is configured to perform applying that comprises:
evaluating an SEC that compares the determined STC with a threshold.

According to another aspect of the presently disclosed subject matter, there is provided a processing circuitry-based method of identifying a financial transactions supervisory event, the method comprising:
a) utilizing one or more machine learning models to classify a plurality of financial transactions of an organization, thereby resulting, for each of the financials transactions, in one or more respective generated transaction attributes,
each of the machine learning models having been trained utilizing, at least, training data derived from historical financial transactions of the organization, and associated classification labels; and
b) applying a predefined transaction rule to the classified transactions, the applying comprising:
   a. evaluating, for each of the classified transactions, a transaction matching criterion that is at least partially based on one or more of the respective generated attributes of the classified transactions, the classified transactions matching the transaction matching criterion thereby constituting a set of selected transactions,
   b. determining a selected transactions characteristic (STC), the determining being based on, at least, one or more transaction characteristics of the transactions constituted in the set of selected transactions,
   c. evaluating a supervisory event criterion (SEC), the supervisory action criterion being based on, at least, the STC, and
   d. identifying a financial transactions supervisory event, responsive to, at least, positive evaluation of the SEC.

This aspect of the disclosed subject matter can further optionally comprise one or more of features (i) to (iii) listed above with respect to the system, mutatis mutandis, in any desired combination or permutation which is technically possible.

According to another aspect of the presently disclosed subject matter, there is provided a computer program product comprising a computer readable non-transitory storage medium containing program instructions, which program instructions when read by a processor, cause the processing circuitry to perform a method of identifying a financial transactions supervisory event, the method comprising:
a) utilizing one or more machine learning models to classify a plurality of financial transactions of an organization, thereby resulting, for each of the financials transactions, in one or more respective generated transaction attributes,
each of the machine learning models having been trained utilizing, at least, training data derived from historical financial transactions of the organization, and associated classification labels; and
b) applying a predefined transaction rule to the classified transactions, the applying comprising:
   a. evaluating, for each of the classified transactions, a transaction matching criterion that is at least partially based on one or more of the respective generated attributes of the classified transactions, the classified transactions matching the transaction matching criterion thereby constituting a set of selected transactions,
   b. determining a selected transactions characteristic (STC), the determining being based on, at least, one or more transaction characteristics of the transactions constituted in the set of selected transactions,
   c. evaluating a supervisory event criterion (SEC), the supervisory action criterion being based on, at least, the STC, and
   d. identifying a financial transactions supervisory event, responsive to, at least, positive evaluation of the SEC.

This aspect of the disclosed subject matter can further optionally comprise one or more of features (i) to (iii) listed above with respect to the system, mutatis mutandis, in any desired combination or permutation which is technically possible.

According to one aspect of the presently disclosed subject matter, there is provided a system of identifying a financial transactions supervisory event, the system comprising a processing circuitry configured to:
a) utilize one or more generative machine learning models to generate one or more recommended actions on behalf of an organization, each of the machine learning models having been trained utilizing, at least, training data derived from historical financial transactions of the organization; and
b) identify a financial transactions supervisory event, based on the recommended action.

According to another aspect of the presently disclosed subject matter, there is provided a method of identifying a financial transactions supervisory event, the method comprising:
a) utilizing one or more generative machine learning models to generate one or more recommended actions on behalf of an organization, each of the machine learning models having been trained utilizing, at least, training data derived from historical financial transactions of the organization; and
b) identifying a financial transactions supervisory event, based on the recommended action.

In addition to the above features, the system according to this aspect of the presently disclosed subject matter can comprise one or more of features (i) to (ii) listed below, in any desired combination or permutation which is technically possible:
(i) the applying additionally comprises:
c) creating a supervisor alert based on the identifying a financial transactions supervisory event.
(ii) at least one of the machine learning models has been trained on data derived from historical supervisor commands.

According to another aspect of the presently disclosed subject matter, there is provided a method of identifying a financial transactions supervisory event, the method comprising:
a) utilizing one or more generative machine learning models to generate one or more recommended actions on behalf of an organization, each of the machine learning models having been trained utilizing, at least, training data derived from historical financial transactions of the organization; and
b) identifying a financial transactions supervisory event, based on the recommended action.

This aspect of the disclosed subject matter can further optionally comprise one or more of features (i) to (ii) listed above with respect to the system, mutatis mutandis, in any desired combination or permutation which is technically possible.

According to another aspect of the presently disclosed subject matter, there is provided a computer program product comprising a computer readable non-transitory storage medium containing program instructions, which program instructions when read by a processor, cause the processing circuitry to perform, the method comprising:
a) utilizing one or more generative machine learning models to generate one or more recommended actions on behalf of an organization,
each of the machine learning models having been trained utilizing, at least, training data derived from historical financial transactions of the organization; and
b) identifying a financial transactions supervisory event, based on the recommended action.

This aspect of the disclosed subject matter can further optionally comprise one or more of features (i) to (ii) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a logical block diagram of an example transactions supervision platform, in accordance with some embodiments of the presently disclosed subject matter;

FIG. 2A illustrates an example rule that defines evaluating a statistical property of a set of transactions sharing an attribute identified by machine-learning-based classification, in accordance with some embodiments of the presently disclosed subject matter;

FIG. 2B illustrates an example rule that defines evaluating a whether a machine-learning-generated financial transaction should be recommended, in accordance with some embodiments of the presently disclosed subject matter;

FIG. 3 illustrates an example method of training a machine learning model utilized in the transaction supervision platform, in accordance with some embodiments of the presently disclosed subject matter;

FIG. 4 illustrates an example method of utilizing a trained a machine learning model to enrich received financial transactions, in accordance with some embodiments of the presently disclosed subject matter;

FIG. 5 illustrates an example method of identifying a financial transactions supervisory event, in accordance with some embodiments of the presently disclosed subject matter; and

FIG. 6 illustrates an example method of identifying a recommended financial transaction, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “encrypting”, “decrypting”, “determining”, “calculating”, “receiving”, “providing”, “obtaining”, “emulating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

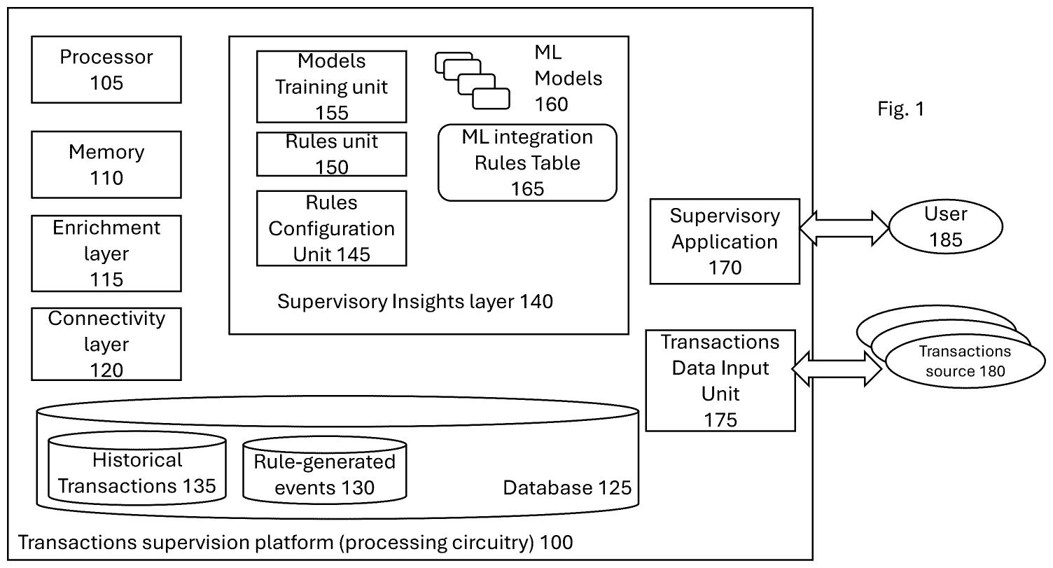

FIG. 1 illustrates a logical block diagram of an example transactions supervision platform, according to some embodiments of the presently disclosed subject matter.

Transactions supervision platform (processing circuitry) 100 can be a processing circuitry-based platform for enabling supervision of financial transactions of an organization. Transactions supervision platform (processing circuitry) 100 can include a processor 105 and a memory 110.

Processor 105 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 105 can also consist, for example, of multiple processors, multiple ASICs, virtual processors, combinations thereof etc.

Memory 110 can be, for example, a suitable kind of volatile and/or non-volatile storage, and can include, for example, a single physical memory component or a plurality of physical memory components. Memory 110 can also include virtual memory. Memory 110 can be configured to, for example, store various data used in computation.

Transactions supervision platform (processing circuitry) 100 can be configured to execute several functional modules in accordance with computer-readable instructions implemented on a non-transitory computer-readable storage medium. Such functional modules are referred to hereinafter as comprised in the processing circuitry. These modules can include, for example, enrichment layer 115, connectivity layer 120, database 125, supervisory insights layer 140, supervisory application 170, and transactions data input unit 175, Transactions source 180 can be a system external to transactions supervision platform (processing circuitry) 100. Multiple instances of transactions source 180 can be present. Each instance of transactions source 180 can be an entity which performs, aggregates, intermediates, or otherwise participates in financial transactions on behalf of an organization.

Transactions data input unit 175 can be e.g. a software module which receives transactions data from e.g. transactions source 180. Transactions data input unit 175 can utilize a suitable wired or wireless communications medium, and can utilize suitable protocols (e.g. Hypertext Transfer Protocol (HTTP)) to receive data.

Financial transactions data can include, for example, data indicative of incoming payments for purposes such as purchases of goods/services, interest or investment payments, tax events/refunds of previous transactions etc. Financial transactions data can also include, for example, data indicative of outgoing payments for purposes such as purchases of goods/services, interest or investment payments, tax events/refunds of previous transactions etc.

Individual financial transactions can include (or be associated with) data such as:
Sum of transaction
Currency
Date of transaction
Identity and financial institution details of transactee
Identity of Intermediary or intermediaries
Purpose of transaction
Etc.

Such transaction data is herein referred to as “transaction characteristics”

Financial transactions can be atomic or bulk: an atomic transaction can represent e.g. a payment from a customer to an organization, whereas a bulk transaction can represent a group of payments from multiple customers (e.g. as accrued and transferred by a credit card company to an organization) or multiple payments to multiple vendors.

Database 125 can be suitable software structure for data storage (e.g. relational database or other appropriate structure).

Database 125 can contain, for example:
a) Historical transactions data: these can include-for example-data indicative of (or derivative of) financial transactions of an organization that have taken place (e.g. received from instances of transactions source 180) and which have been communicated to transactions supervision platform 100 via e.g. transactions data input unit 175.
b) Rules-generated events: these can include-for example-data indicative of events that were generated by application of rules that are part of ML integration rules table 165, as described below. By way of non-limiting example: a recommended action (e.g. as suggested by a generative ML model 160) can be a rule-generated event, as described below. Rules-generated events can be eventually presented to user 185 via supervisory application 170.

Enrichment layer 115 can be a software module which analyzes transactions and/or utilizes external data sources to “enrich” the transactions data by e.g. adding metadata.

Supervisory insight layer 140 can be a software module which provides a supervisor with potentially actionable generalizations or observations pertaining to a plurality of an organization's financials transactions. Supervisory insight layer 140 can also provide observations regarding a particular transaction (e.g. that a duplicate payment appears to have occurred). Supervisory insight layer 140 can provide notifications of temporal changes in a statistical measurement over a particular plurality of financial transactions. For example: supervisory insight layer 140 can provide month-by-month total revenue, month-by-month change in total revenue etc.

To provide these generalization/observations, supervisory insight layer 140 can employ rules which e.g.:
select historical transactions from database 125,
extract relevant fields of transactions, and
perform prespecified calculations on the extracted fields.

It is noted that the organization's transactions stored in database 125 represent a wealth of data regarding organizational finances business characteristics. Thus it is desirable for supervisory insight layer 140 to provide additional supervisory insights beyond what can be derived from strict application of methods based only on performing calculations and pattern-matching of transaction fields.

Some embodiments of the presently disclosed subject matter utilize a particular method to integrate machine-learning based transaction analysis with rules-based analysis, as detailed hereinbelow. Some such embodiments utilize a rule table in which rules can be based on machine-learning derived transaction attributes in addition to the received fields/metadata of transactions.

Accordingly: supervisory insight layer 140 can include supervisory insights machine learning (ML) integration rules table 165. Supervisory insights ML integration rules table 165 can be stored data indicative of rules (e.g. machine-learning-utilizing rules) that supervisory insight layer 140 can apply to transactions (e.g. to groups of historical transactions) for deeper analysis.

Supervisory insights ML integration rules table 165 can include rules that refer to a machine learning-derived transaction attribute (i.e. alone or in combination other non-ML attributes of a transaction). Supervisory insights ML integration rules table 165 can also include other kinds of rules.

Supervisory insights ML integration rules table 165 can includes rules which apply to an entire group of historical transactions. Rules in supervisory insights ML integration rules table 165 can specify operations to perform on certain subsets of historical transactions (e.g. calculating a statistic). Such rules can also identify actions to be performed in response to results of such operations meeting a particular criterion.

Accordingly, supervisory insights ML integration rules table 165 can be viewed as a mechanism for deriving supervisory insights on the whole (or part) of historical transaction data, by utilizing a combination of e.g. machine learning-derived attributes, statistics or other analysis of transaction data, and predefined rules.

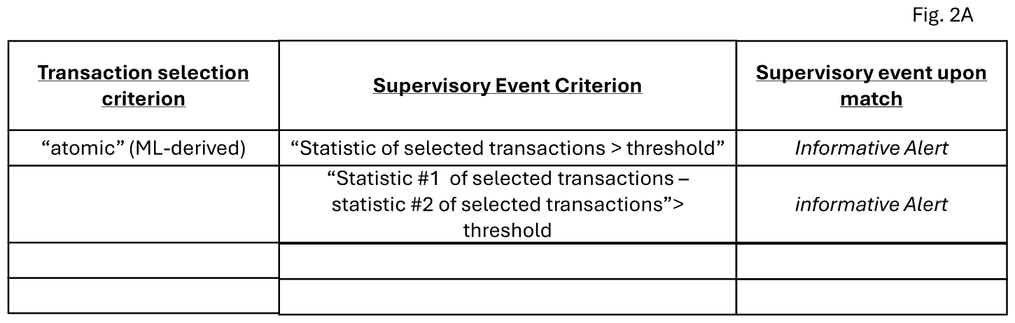

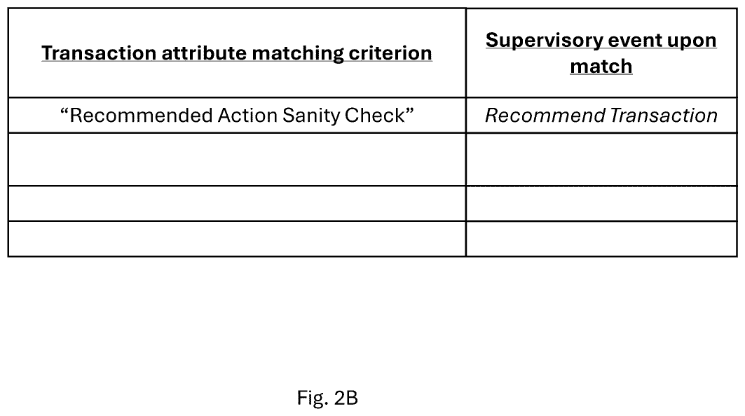

Example structures of entries in supervisory insights ML integration rules table 165 are described below, with reference to FIG. 2.

Supervisory insight layer 140 can further include machine learning (ML) models 160. ML models 160 can be one or more machine learning models of suitable types which are adapted for e.g. classification of financial transactions or for generation of data pertaining to financial transactions.

ML models 160 can include classification models, generative models, and/or other types of models.

Supervisory insight layer 140 can provide software-based methods of training ML models 160. Models training unit 155 can be a software submodule which includes these methods.

In some embodiments, supervisory insight layer 140 can, e.g. responsive to a configuration option, train an ML model of ML models 160 in a specific fashion based on incoming and/or historical transaction data (or subsets thereof).

In some such embodiments, supervisory insight layer 140 can provide an interface (e.g. a web-based interface) enabling an organization to specify the training of an ML model of ML models 160. For example, the API can enable the organization to specify transactions (and optionally: associated classification labels) to be used to the train the machine learning model.

For example: supervisory insight layer 140 can provide a classification ML model suitable for distinguishing atomic transactions from bulk transactions. Models training unit 155 can then receive data indicative of transactions (e.g. historical transactions, containing e.g. name of transactee, transaction sum, etc.) together with respective labels indicating “atomic” or “bulk”, and then use these transactions and labels to train the relevant machine learning model of ML models 160. The trained model can then be utilized to classify other transactions, i.e. to label them as “atomic” or “bulk.” By way of further non-limiting example: supervisory insight layer 140 can provide a generative model suitable for generating suggested actions (e.g. suggested transactions). Models training unit 155 can receive data indicative of transactions (e.g. historical transactions), and then use these transactions to train the relevant machine learning model of ML models 160. The trained model can then subsequently be utilized to generate recommended transactions. For example: the trained model might generate a suggestion to pay rent on the first day of the month. The ML model can, in some examples, be further trained based on user/supervisor behavior in response to suggestions (i.e. reinforcement learning)

Rules configuration unit 145 can perform configuration of rules in supervisory insights ML integration rules table 165 (for example: in response to requests from supervisor application 170.

Rules unit 150 can apply rules of supervisory insights ML integration rules table 160 to transactions. For example:
Rules unit 150 can periodically (or in response to an event) apply rules to historical transactions
In some examples, rules unit 150 can apply rules to new incoming transactions (e.g. as received from transactions data input unit 175)

Supervisory application 170 can be an application (e.g. web-based) utilized by user 185. Supervisory application 170 can provide user 185 with an ability to control and/or configured transactions supervision platform 100, as well to monitor transactions and associated data, such as analysis of transactions or suggested actions as generated by rules unit 150.

It is noted that the teachings of the presently disclosed subject matter are not bound by the system described with reference to FIG. 1 or subsequent diagrams.

Equivalent and/or modified functionality can be consolidated or divided in another manner and can be implemented in any appropriate combination of software with firmware and/or hardware and executed on a suitable device. The system can be a standalone entity, or integrated, fully or partly, with other entities.

FIGS. 2A-2B illustrate example rule structures utilized in a transactions supervision platform, according to some embodiments of the presently disclosed subject matter.

It is noted that supervisory insights ML integration rules table 165 can be structured in any suitable manner, and can use any type of configuration mechanism and display mechanism. For example, transactions supervision platform can provide a web-based interface for manual configuration of rules by a user/supervisor. Alternatively, transactions supervision platform can receive a Javascript Object Notation (JSON) configuration file, or use another suitable mechanism.

It is further noted that supervisory insights ML integration rules table 165 is a logical table. As such, supervisory insights ML integration rules table 165 need not consist of or utilize data in some particular format which represents the rules. For example: in some embodiments, rules can be defined using a suitably complex rule definition syntax. Moreover, a software module which executes code implementing the rules in a “hardcoded” fashion can implicitly contain supervisory insights ML integration rules table 165.

It is further noted that rules structures shown in FIGS. 2A-2B accordingly illustrate rules structures in a simple and stylized fashion, in order to clearly explain the functionality that they can provide.

FIG. 2A illustrates an example rule that defines evaluating a statistical property of a set of transactions sharing an attribute identified by machine-learning-based classification.

A rule can include a “transaction selection criterion” i.e. a criterion to be applied to each transaction of a set of historical transactions to identify which transactions should be selected for further evaluation. In the first example of FIG. 2A, the transaction selection criterion is whether or not the transaction is atomic (as opposed to a “bulk”) transaction. In some embodiments, whether a transaction is atomic or bulk is derived using machine learning, as described above. The transaction selection criterion can be more complex. For example: a transaction selection criterion could select for atomic transactions that took place within a specific month.

The rule can include a “supervisory event criterion” i.e. a criterion which determines whether the selected transactions “meet” the rule-and thus indicate a supervisory event such as an alert to a supervisor/user.

In some examples, a supervisory event criterion can be based on a characteristic of derived from analysis of the selected transactions. In the current example, the supervisory event criterion is based on whether a particular statistic (e.g. average transaction amount, mean transaction amount, average days of overdue payment etc.) is greater than some threshold. This statistic or other computed value is herein termed the “selected transactions characteristic”.

The second example in FIG. 2A is more complex. In this case the supervisory event criterion is whether a mean transaction amount (of atomic transactions only) of the current month exceeds the mean transaction amount (of atomic transactions only) of the previous month by a difference that exceeds a threshold. In this example, the supervisory event criterion is based on two different selected transactions characteristics (i.e. a) the mean transaction amount of atomic payments of the current month, and b) the mean transaction amount of atomic payments of the previous month).

It is noted that providing definition of predefined rules to be applied to groups of historical transactions in this manner (i.e. with transaction selection based on machine learning, and with supervisory event criteria based on selected transactions characteristics) enables an organization to achieve deeper analysis of data and maintain better awareness of its financial trends.

The rule can include a supervisory event to perform upon match, which in the present examples is generating an alert (e.g. with text indicating the particular calculated statistics) which would be viewed by the user of the supervisory application.

FIG. 2B illustrates an example rule that defines evaluating a whether a machine-learning-generated financial transaction should be recommended (e.g. via the supervisory application). The rule includes a transaction attribute matching criterion (in this case a “sanity check” which might validate a payee, date, amount, etc.), and a supervisory event upon match (i.e. recommending the transaction).

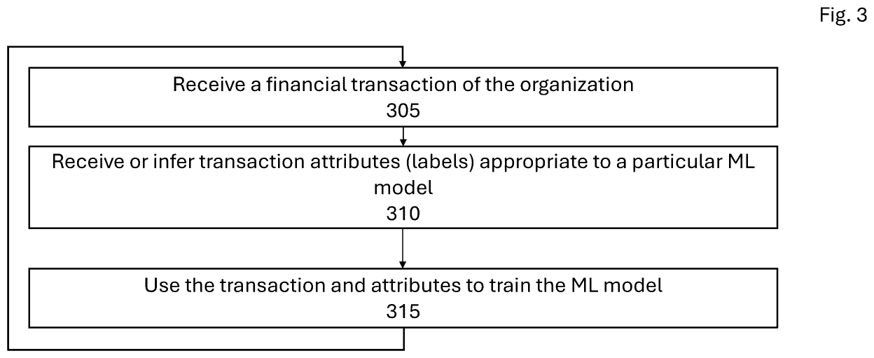

FIG. 3 illustrates an example method of training a machine learning model utilized in the transaction supervision platform, according to some embodiments of the presently disclosed subject matter.

As described hereinabove, ML models 160 can be trained based on historical transactions of an organization-optionally in combination with labels that are prepared manually or automatically. After training, the models of ML models 160 can then be utilized in processing of new transactions.

In some examples, a large number of historical transactions (optionally with labels) are installed at once in the transaction supervision platform (processing circuitry) 100, and transaction supervision platform (processing circuitry) 100 (e.g. models training unit 155) can train ML models 160 before transaction supervision platform (processing circuitry) 100 begins operation. In some other examples, transaction supervision platform (processing circuitry) 100 trains ML models 160 with new transactions (e.g. as they are received), or after a requisite number of transactions has been received. In some examples, models of ML models 160 are periodically retrained.

Transactions supervision platform (processing circuitry) 100 (e.g. models training unit 155) can begin training by receiving 305 one or more financial transactions of the organization (e.g. historical financial transactions stored in historical transactions 135 of database 125.

Transactions supervision platform (processing circuitry) 100 (e.g. rules unit 150) can next receive transaction attributes (labels) appropriate to a particular ML model. In some examples, the labels are the result of manual classification of transactions. In other examples, the labels are created through an automated process, or a combination of a manual and automated process. In some examples, Transactions supervision platform (processing circuitry) 100 (e.g. rules unit 150) performs label creation itself.

Transactions supervision platform (processing circuitry) 100 (e.g. rules unit 150) can utilize model specific mechanisms to use the transaction and attributes the ML model of ML models 160.

It is noted that the teachings of the presently disclosed subject matter are not bound by the flow diagrams illustrated in FIG. 3 or subsequent figures, the illustrated operations can occur substantially concurrently, or out of the illustrated order. It is also noted that whilst the flow chart is described with reference to elements of the system FIG. 1, this is by no means binding, and the operations can be performed by elements other than those described herein.

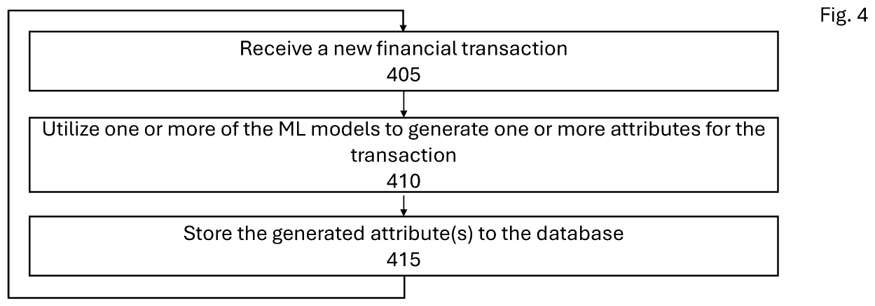

FIG. 4 illustrates an example method of utilizing a trained a machine learning model to enrich received financial transactions, according to some embodiments of the presently disclosed subject matter.

Transactions supervision platform (processing circuitry) 100 (e.g. rules configuration unit 145) can receive 405 a new financial transaction (e.g. from transactions data input unit 175).

Transactions supervision platform (processing circuitry) 100 (e.g. rules configuration unit 145) can then utilize one or more of ML models 160 to classify the received transaction, thereby generating one or more attributes for the transaction. By way of non-limiting example: transactions supervision platform (processing circuitry) 100 (e.g. rules configuration unit 145) can utilize a classification machine learning model that has been trained to classify a financial transaction as either “bulk”or “atomic”.

Transactions supervision platform (processing circuitry) 100 (e.g. rules configuration unit 145) can then store 415 the generated attribute(s) to e.g. database 125 (e.g. historical transactions 135).

It is noted that transactions supervision platform (processing circuitry) 100 (e.g. rules configuration unit 145) is not required to enrich arriving transactions with the machine-learning derived classification data as shown in FIG. 4. Transactions supervision platform (processing circuitry) 100 (e.g. rules configuration unit 145) can instead classify and enrich the transaction records at a time subsequent to reception (e.g. in a “batch mode” which processes multiple transactions from database 125). Alternatively, transactions supervision platform (processing circuitry) 100 can perform classification while evaluating rules in supervisory insights ML integration rules table 165. Alternatively, other suitable methods can be utilized.

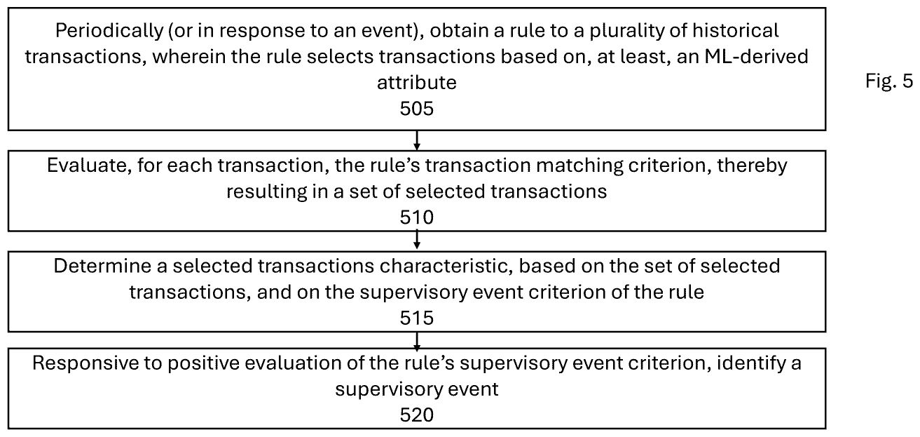

FIG. 5 illustrates an example method of identifying a financial transactions supervisory event, according to some embodiments of the presently disclosed subject matter.

As described above, supervisory insights ML integrations rules table 165 can include rules which examine different fields of financial transactions, and can then use this data (optionally in combination with machine learning) to identify supervisory events. The method illustrated in FIG. 5 operates on historical transactions, and exemplifies processing of a rule in which multiple transactions are selected via a selection criterion (which in turn can utilize attributes that were generated by machine-learning), and in which a supervisory event criterion is then evaluated based on these selected transactions. Transactions supervision platform (processing circuitry) 100 (e.g. rules unit 150) can perform the method outlined in FIG. 5, for example, periodically, or in response to an event such as a supervisor request.

Transactions supervision platform (processing circuitry) 100 (e.g. rules unit 150) can obtain 505 a rule of supervisory insights ML integrations rules table 165 to a plurality of historical transactions (for example: all historical transactions of database 125). As described above with reference to FIG. 2A, a rule of ML integrations rules table 165 can include a “transaction selection criterion” that is at least partially machine-learning-based (e.g. utilizes a machine-learning-derived transaction attribute as described above with reference to FIG. 4). By way of non-limiting example: transactions supervision platform (processing circuitry) 100 (e.g. rules unit 150) can apply a rule which includes a transaction selection criterion specifying all transactions that were determined to be “atomic”.

As described above with reference to FIG. 2A, the rule can further include a supervisory event criterion, which in turn can utilize a selected transactions characteristic. Transactions supervision platform (processing circuitry) 100 (e.g. rules unit 150) can evaluate 510 the rule's transaction matching criterion, for each transaction, thereby resulting in a set of selected transactions. For example: if the rule specifies a transaction matching criterion of “atomic” transactions supervision platform (processing circuitry) 100 (e.g. rules unit 150) can evaluate each transaction and select the transactions with the attribute of “atomic”.

Transactions supervision platform (processing circuitry) 100 (e.g. rules unit 150) can determine 515 a selected transactions characteristic, based on the set of selected transactions, and on the supervisory event criterion of the rule. It is recalled that a selected transactions characteristic is a statistic or other computed value that is calculated over the set of selected transactions (e.g. the mean transaction amount).

It is noted that one or more selected transactions characteristics can be specified in the supervisory event criterion of a rule (as described above). It is further noted that, in some examples, a selected transactions characteristic can be calculated over a subset of the set of selected transactions. It is further noted that, in some examples, a selected transactions characteristic can utilize other data in addition to the data of the set of selected transactions.

Transactions supervision platform (processing circuitry) 100 (e.g. rules unit 150) can evaluate the rule's supervisory event criterion, and responsive to positive evaluation of the criterion (e.g. the mean transaction amount exceeding a threshold) identify 520 the supervision event identified by the rule (e.g. generating an alert, which can then be stored in rule-generated events 130, and then later on displayed to a user or supervisor).

Transactions supervision platform (processing circuitry) 100 (e.g. rules unit 150) can perform the method outlined in FIG. 5 for multiple rules in supervisory insights ML integrations rules table 165.

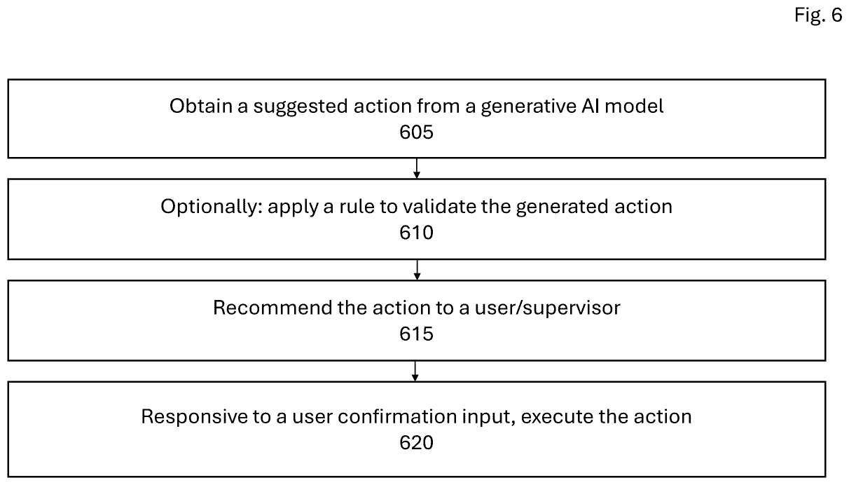

FIG. 6 illustrates an example method of identifying a recommended financial transaction, according to some embodiments of the presently disclosed subject matter.

Transactions supervision platform (processing circuitry) 100 (e.g. rules unit 150) can obtain 605 a suggested action (e.g. a suggested transaction) from a trained machine learning model.

Optionally, transactions supervision platform (processing circuitry) 100 (e.g. rules unit 150) can apply 610 a rule of supervisory insights ML integrations rules table 165 to the generated action. For example, the rule can specify a “sanity check” on the generated action-as described above with reference to FIG. 2B.

Transactions supervision platform (processing circuitry) 100 (e.g. rules unit 150) can recommend 615 the suggested transaction to the user/supervisor. For example, Transactions supervision platform (processing circuitry) 100 (e.g. rules unit 150) can store data indicative of the generated transaction to rule-generated events 130 in database 125, for access by supervisory application 170.

Transactions supervision platform (processing circuitry) 100 (e.g. supervisory application 170) can then, responsive to a supervisor's indication of acceptance or command, execute 620 the recommended action (e.g. transaction).

If the user or supervisor approves the recommended transaction, then transactions supervision platform (processing circuitry) 100 (e.g. rules unit 150) can execute the transaction.

It is noted that a generative machine learning model 160 can also be trained on commands or indications of acceptance by a supervisor of the organization. This provides a form of reinforcement learning for the action generation.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A system of identifying a financial transactions supervisory event, the system comprising a processing circuitry configured to:
a) utilize one or more machine learning models to classify a plurality of financial transactions of an organization, thereby resulting, for each of the financials transactions, in one or more respective generated transaction attributes,
each of the machine learning models having been trained utilizing, at least, training data derived from historical financial transactions of the organization, and associated classification labels; and
b) apply a predefined transaction rule to the classified transactions, the applying comprising:
a. evaluating, for each of the classified transactions, a transaction matching criterion that is at least partially based on one or more of the respective generated attributes of the classified transactions, the classified transactions matching the transaction matching criterion thereby constituting a set of selected transactions,
b. determining a selected transactions characteristic (STC), the determining being based on, at least, one or more transaction characteristics of the transactions constituted in the set of selected transactions,
c. evaluating a supervisory event criterion (SEC), the supervisory action criterion being based on, at least, the STC, and
d. identifying a financial transactions supervisory event, responsive to, at least, positive evaluation of the SEC.

2. The system of claim 1, wherein the applying additionally comprises:
e. creating a supervisor alert based on the identifying a financial transactions supervisory event.

3. The system of claim 1, wherein the processing circuitry is configured to perform applying that comprises:
determining an STC that is a statistic based on a transaction characteristic of each transaction of the set of selected transactions.

4. The system of claim 1, wherein the processing circuitry is configured to perform applying that comprises:
evaluating an SEC that compares the determined STC with a threshold.

5. A processing circuitry-based method of identifying a financial transactions supervisory event, the method comprising:
a) utilizing one or more machine learning models to classify a plurality of financial transactions of an organization, thereby resulting, for each of the financials transactions, in one or more respective generated transaction attributes,
each of the machine learning models having been trained utilizing, at least, training data derived from historical financial transactions of the organization, and associated classification labels; and
b) applying a predefined transaction rule to the classified transactions, the applying comprising:
a. evaluating, for each of the classified transactions, a transaction matching criterion that is at least partially based on one or more of the respective generated attributes of the classified transactions, the classified transactions matching the transaction matching criterion thereby constituting a set of selected transactions,
b. determining a selected transactions characteristic (STC), the determining being based on, at least, one or more transaction characteristics of the transactions constituted in the set of selected transactions,
c. evaluating a supervisory event criterion (SEC), the supervisory action criterion being based on, at least, the STC, and
d. identifying a financial transactions supervisory event, responsive to, at least, positive evaluation of the SEC.

6. A computer program product comprising a computer readable non-transitory storage medium containing program instructions, which program instructions when read by a processor, cause the processing circuitry to perform a method of identifying a financial transactions supervisory event, the method comprising:
a) utilizing one or more machine learning models to classify a plurality of financial transactions of an organization, thereby resulting, for each of the financials transactions, in one or more respective generated transaction attributes,
each of the machine learning models having been trained utilizing, at least, training data derived from historical financial transactions of the organization, and associated classification labels; and
b) applying a predefined transaction rule to the classified transactions, the applying comprising:
a. evaluating, for each of the classified transactions, a transaction matching criterion that is at least partially based on one or more of the respective generated attributes of the classified transactions, the classified transactions matching the transaction matching criterion thereby constituting a set of selected transactions,
b. determining a selected transactions characteristic (STC), the determining being based on, at least, one or more transaction characteristics of the transactions constituted in the set of selected transactions,
c. evaluating a supervisory event criterion (SEC), the supervisory action criterion being based on, at least, the STC, and identifying a financial transactions supervisory event, responsive to, at least, positive evaluation of the SEC.

7-11. (canceled)
